(19) United States
(12) Patent Application Publication
(10) Pub. No.: US 2014/0196079 A1
(43) Pub. Date: Jul. 10, 2014

(54) VIDEO DISTRIBUTION AND PLAYBACK

(71) Applicant: RED.COM, Inc., Irvine, CA (US)

(72) Inventors: James H. Jannard, Las Vegas, NV (US); Peter Jarred Land, Los Angeles, CA (US); Rob Wouter Lohman, Lake Forest, CA (US); Jon Flickinger, Topeka, KS (US); Jon Anthony Farhat, Los Angeles, CA (US); Stuart J. English, Rancho Santa Margarita, CA (US); Thomas Graeme Nattress, Acton (CA)

(73) Assignee: RED.COM, Inc., Irvine, CA (US)

(21) Appl. No.: 14/050,240

(22) Filed: Oct. 9, 2013

Related U.S. Application Data
(60) Provisional application No. 61/712,172, filed on Oct. 10, 2012.
(60) Provisional application No. 61/712,152, filed on Oct. 10, 2012.
(60) Provisional application No. 61/712,184, filed on Oct. 10, 2012.
(60) Provisional application No. 61/712,175, filed on Oct. 10, 2012.
(60) Provisional application No. 61/712,174, filed on Oct. 10, 2012.
(60) Provisional application No. 61/712,185, filed on Oct. 10, 2012.
(60) Provisional application No. 61/712,182, filed on Oct. 10, 2012.
(60) Provisional application No. 61/712,189, filed on Oct. 10, 2012.
(60) Provisional application No. 61/809,279, filed on Apr. 5, 2013.
(60) Provisional application No. 61/809,276, filed on Apr. 5, 2013.

(51) Int. Cl. H04N 21/266; H04N 7/167

(52) U.S. Cl. CPC H04N 21/26613; H04N 7/1675
USPC 725/31

(57) ABSTRACT

Systems and methods are disclosed for providing a content delivery network with one or more network-connected audiovisual players. A content delivery network provider can provide an access module residing within a network-connected audiovisual player wherein the access module can be configured to control the player. The access module can be configured to function within a gateway environment on the player such that the gateway environment passes commands from the access module to the firmware or secure module on the player operating in a secure environment. As a result, each player with the access module can become a part of the content delivery network as the content delivery network provider can control the network-connected audiovisual players. The content delivery network can implement multi-level access controls to licenses and encryption keys to secure audiovisual content.

### CROSS-REFERENCE TO RELATED APPLICATIONS

This application claims the benefit of priority under 35 U.S.C. §119(e) to U.S. Provisional Patent Application No. 61/712,172, filed Oct. 10, 2012, entitled “VIDEO DISTRIBUTION AND PLAYBACK” (REDCOM.083PR), to U.S. Provisional Patent Application No. 61/712,152, filed Oct. 10, 2012, entitled “VIDEO DISTRIBUTION AND PLAYBACK” (REDCOM.083PR2), to U.S. Provisional Patent Application No. 61/712,184, filed Oct. 10, 2012, entitled “VIDEO DISTRIBUTION AND PLAYBACK” (REDCOM.083PR3), to U.S. Provisional Patent Application No. 61/712,175, filed Oct. 10, 2012, entitled “VIDEO DISTRIBUTION AND PLAYBACK” (REDCOM.083PR4), to U.S. Provisional Patent Application No. 61/712,174, filed Oct. 10, 2012, entitled “VIDEO DISTRIBUTION AND PLAYBACK” (REDCOM.083PR5), to U.S. Provisional Patent Application No. 61/712,185, filed Oct. 10, 2012, entitled “VIDEO DISTRIBUTION AND PLAYBACK” (REDCOM.083PR6), to U.S. Provisional Patent Application No. 61/712,182, filed Oct. 10, 2012, entitled “VIDEO DISTRIBUTION AND PLAYBACK” (REDCOM.083PR7), to U.S. Provisional Patent Application No. 61/712,189, filed Oct. 10, 2012, entitled “VIDEO DISTRIBUTION AND PLAYBACK” (REDCOM.083PR8), to U.S. Provisional Patent Application No. 61/809,279, filed Apr. 5, 2013, entitled “DISTRIBUTING AUDIOVISUAL CONTENT OVER A NETWORK” (REDCOM.083PR9), to U.S. Provisional Patent Application No. 61/809,276, filed Oct. 10, 2012, entitled “DISTRIBUTING AUDIOVISUAL CONTENT OVER A NETWORK” (REDCOM.083PR10). Each of the foregoing applications is expressly incorporated by reference herein in its entirety so as to form part of this specification.

### BACKGROUND

1. Field

The present disclosure relates generally to distribution of audiovisual content over a network.

2. Description of Related Art

A content distributor generally distributes audiovisual content, such as television shows, movies, or other videos, over a network to compatible and capable devices. The content distributor can receive the content from an author or other original source, such as a movie studio, and distribute it to network-connected playback devices configured to retrieve and play such content. The network-connected devices can be configured to request a particular audiovisual asset, which can then be transmitted directly to the device and streamed to the user or downloaded to the device and presented after it has been downloaded. For security purposes, the content can be encrypted at any point in the chain of delivery from the author to the content distributor to the playback device. An authorized device, then, would be able to decrypt the content and play it back while an unauthorized device would be unable to decrypt the content.

### SUMMARY

The systems, methods and devices of the disclosure each have innovative aspects, no single one of which is indispensable or solely responsible for the desirable attributes disclosed herein. Without limiting the scope of the claims, some of the advantageous features will now be summarized.

In some embodiments, systems and methods are provided for implementing and managing an audiovisual device over a network. The present disclosure also provides for systems and methods for providing a content delivery network with one or more network-connected audiovisual players. A content delivery network provider can use the systems and methods provided herein to provide an access module residing within the network-connected audiovisual player wherein the access module can be configured to control the player. The access module can be configured to function within a gateway environment on the player such that the gateway environment passes commands from the access module to the firmware or secure module on the player operating in a secure environment. As a result, each player with the access module can become a part of the content delivery network as the content delivery network provider can control the network-connected audiovisual players. For example, a provider of a content delivery network can choose to write an access module (e.g., a Java application) to function within the gateway environment of a player. This application can then pass application program interface (“API”) commands to the player, thereby effectively establishing the audiovisual player as a part of their own network. As a part of the network, an audiovisual player can be configured to seed content to other audiovisual players or other nodes on the network, such as through peer-to-peer file sharing protocols (e.g., bit-torrent).

In some embodiments, systems and methods are provided for distributing audiovisual content over a network. The audiovisual content can be associated with a license that can be modified by each distributor in the distribution chain such that any attempted playback of the audiovisual content is subject to the restrictions in the associated license. The audiovisual content can be encrypted along the distribution chain such that only the intended and authorized recipient is able to access the content. The key used to decrypt the audiovisual content can itself be encrypted and delivered with the associated license, separate from or together with the audiovisual content. An audiovisual player that receives the audiovisual content can be configured to decrypt the license and key to enable decryption of the content.

In some embodiments, an audiovisual asset is provided which has a plurality of associated presentations or versions (e.g., a theatrical cut and a director's cut of a movie). The audiovisual asset can include a plurality of audiovisual clips. The asset can include a playlist associated with each presentation which includes a list of one or more of the plurality of audiovisual clips and an order in which to present the clips to provide the associated presentation. The playlist can also include a starting point and/or duration of each clip to be presented. Advantageously, this can allow a distributor of the audiovisual asset to provide access to multiple versions of the asset without providing each version as a separate digital file, saving on bandwidth, time, computing resources, and cost.

In some embodiments, an authoring tool is provided which receives an audiovisual asset and generates one or more audiovisual clips, one or more presentations, and the one or more playlists associated with each presentation, wherein the playlist includes a list of the one or more audiovisual clips to present and the order in which to present them. The authoring tool can be configured to encode the plurality of audiovisual clips into a file format compatible with recipient devices. The authoring tool can be configured to generate an author license associated with the audiovisual asset. The author license can include access restrictions which limit or prevent access to the audiovisual asset based on included parameters. For example, the author license can include a release date which limits or prevents a recipient system from accessing the audiovisual for playback before the release date. In certain implementations, the authoring tool can encrypt the asset and/or the author license. In certain implementations, the authoring tool can digitally sign the license for security purposes. In some implementations, the authoring tool can receive a modified license from a content distributor and encrypt and/or digitally sign the modified license, which results in a verified license.

In some embodiments, an audiovisual player is provided which is configured to receive an audiovisual asset and one or more associated playlists, and present a version of the audiovisual asset based at least in part on the information provided in the playlist. In some implementations, the audiovisual player can be configured to display the presentation when a subset of the clips in the playlist is available on the playback device. In certain implementations, the audiovisual player can be configured to stream the asset over the network, to playback the asset after a portion of the asset has been transferred to the device, or to playback the asset after the entirety of the asset has been transferred to the device.

In some embodiments, the audiovisual player can be configured to decrypt an encrypted audiovisual asset by first decrypting the license associated with the asset to obtain the asset encryption key. The audiovisual player can then use the asset encryption key to decrypt the asset for playback, if restrictions in the decrypted license are satisfied. In some implementations, the audiovisual asset is encrypted using a symmetric key. The audiovisual player can receive the encrypted audiovisual asset over a network or through physical ingest (e.g., using a USB drive or other connected non-transitory storage device). At the same time or at a different time, the audiovisual player can receive an encrypted license associated with the asset, wherein the encrypted license also includes the symmetric key. The encrypted license and symmetric key can have multiple layers of encryption. For example, the license and symmetric key can be encrypted using asymmetric encryption techniques using public and private key pairs. The license and symmetric key can be encrypted using a first public asymmetric key associated with a global private asymmetric key present on compatible playback devices. This results in a first layer of encryption, or a base-encrypted license and symmetric key. The base-encrypted license and symmetric key can be encrypted using a second public asymmetric key associated with an intended recipient of the asset, such as an intermediary distributor or a playback device. This results in a target-encrypted license and symmetric key. The intended recipient can include the complementary private key to unwrap this second layer of encryption, to decrypt the target-encrypted license and symmetric key. Advantageously, this allows an audiovisual asset to be distributed in an encrypted state, limiting access to the asset to authorized recipient machines. Furthermore, the associated encryption key can be distributed separate from the asset and be encrypted, along with the license containing access restrictions associated with the asset, all along the chain of distribution until it arrives at an authorized playback device.

In some embodiments, rights management system is provided which receives an asset and a license and encodes the asset and encrypts the license and encoded asset. The rights management system can modify the received license to add restrictions. The rights management system can digitally sign the license for validation purposes. The rights management system can perform multiple layers of encryption. For example, the rights management system can generate a symmetric key and encrypt the asset using this key. The rights management system can then encrypt the symmetric key and the modified license using a first public asymmetric key corresponding to a private asymmetric key present on authorized playback devices. The rights management system can perform another layer of encryption, using a second public asymmetric key corresponding to a private asymmetric key present on an intended recipient of the license and symmetric key. The intended recipient can be a content distributor, a playback device, or another entity in the chain of distribution.

### BRIEF DESCRIPTION OF THE DRAWINGS

The drawings are provided to illustrate example embodiments described herein and are not intended to limit the scope of the disclosure. Throughout the drawings, reference numbers may be re-used to indicate general correspondence between referenced elements.

FIG. 1 illustrates a block diagram representing an example content distribution chain including an asset server, a content distributor, and a plurality of playback devices.

FIG. 2 illustrates a block diagram of a rights management tool configured to provide a secure license associated with an audiovisual asset.

FIGS. 3A and 3B illustrate block diagrams of example distribution chains which encrypt audiovisual assets, licenses, and encryption keys.

FIG. 4 illustrates a block diagram of multiple layers of encryption configured to limit access to an asset encryption key.

FIG. 5 illustrates a block diagram of an example player having a gateway environment with an access module and a secure environment in communication with the access module through a library of commands.

FIG. 6 illustrates an example file format associated with an audiovisual asset which includes a plurality of packages each with one or more playlists.

FIGS. 7A and 7B illustrate example playlist files dictating presentation of audiovisual clips associated with a presentation of an audiovisual asset.

FIG. 8 illustrates example file formats associated with audiovisual clips and audiovisual chunks.

FIG. 9 illustrates a block diagram showing the flow of data from an authoring tool to an audiovisual playback device.

FIG. 10 illustrates a flow chart of an example method of securely distributing and playing an audiovisual asset.

FIG. 11 illustrates a flow chart of an example method of playing an encrypted and licensed audiovisual asset.

FIG. 12 illustrates a flow chart of an example method of licensing an audiovisual asset.

### DETAILED DESCRIPTION

In the following description, reference is made to the accompanying drawings. It is to be understood that other structures and/or embodiments may be utilized. Various aspects of the disclosure will be described with regard to certain examples and embodiments, which are intended to illustrate but not to limit the disclosure. Nothing in this disclosure is intended to imply that any particular feature or characteristic of the disclosed embodiments is essential.

A content distribution network can include multiple systems or components for creating audiovisual assets, encrypting the assets, providing licenses for the assets, delivering the assets, accessing the assets, decrypting the assets, and/or displaying or presenting the assets. Components of the system can include one or more audiovisual players, access modules on the players, an encoder system, asset servers, encryption and licensing systems, authoring tools, and the like. Systems in the content distribution network can be configured to control an audiovisual player through an access module or by providing the audiovisual player commands that are interpreted by the access module residing on the audiovisual player which effectively allows the system in the content distribution network to control aspects of the audiovisual player. The access module residing on the audiovisual player can operate in a gateway environment on the player and the access module can provide commands to modules and systems operating in a secure environment through a list of commands, the list of commands being provided in an application program interface (“API”). Advantageously, the API can allow a provider in the content distribution network to craft an associated or proprietary access module that provides capabilities according to the provider's desires, network characteristics, distribution model, and the like. The access module created by the provider can be configured to be implemented on one or more audiovisual playback devices in the content delivery network.

### Content Delivery System

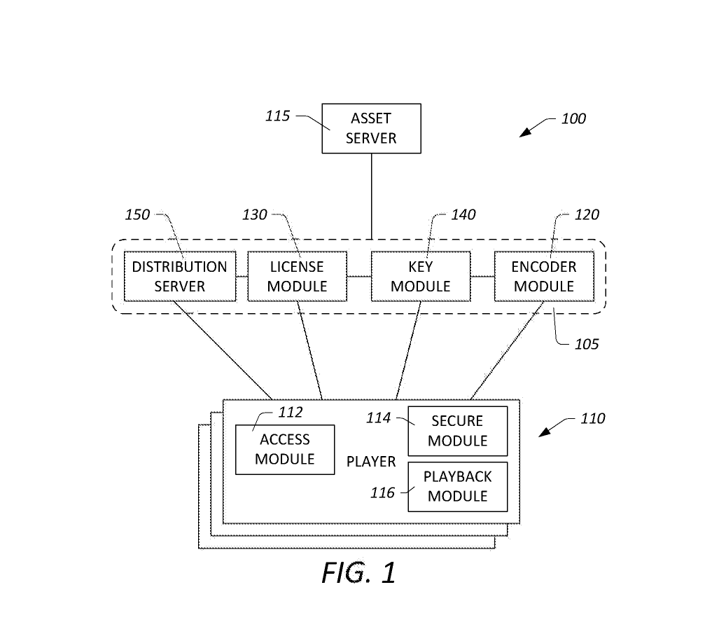

FIG. 1 illustrates a block diagram representing an example content distribution chain 100 including a content distributor 105, a plurality of audiovisual players 110, and an asset server 115. The plurality of audiovisual players 110 are communicably coupled to a content delivery network 105 through a network connection, such as a local area network (“LAN”) or wide area network (“WAN”). The content distribution chain 100 can include multiple components configured to provide a variety of functionality to the content distributor 105. For example, the content distributor 105 can include an encoder module 120, a license module 130, a key module 140, and a distribution server 150.

The content delivery system 100 includes one or more players 110 configured to provide or display audiovisual content on a display such as a television, monitor, or the like. The player 110 can be a device adapted to deliver video content to a display. For example, the video content can be video having a 4096×2160 pixel resolution and a frame rate of about 60 fps. In some embodiments, the player 110 can have two decoder chips which are configured to output video data with a frame rate of 120 fps and/or 4096×2160 pixel video data in stereoscopic 3D with both chips running at about 60 fps. The player 110 can output audio which supports 5.1 channels of 24-bit 48 kHz LPCM audio via one HDMI 1.4 connector. The player 110 can be configured to ingest content via a network or connected data storage (e.g., a USB drive). The player 110 can be configured to play back ingested content provided a license to that content is on the player 110 or is retrieved from the distributor 105.

Each player 110 can include an access module 112 configured to receive commands from the content distributor 105. Commands can be received from any system in the content distribution network 100, such as content distributors, third-party systems, or other network-connected players 110, which allows the content distribution network 100 to operate the player 110 as an extension of the network infrastructure. The access module 112 can be configured to receive any number of commands from the network 105, interpret them, and send them to a secure module 114 of the player 110 which allows access to internal functionality of the player in a secure environment. In this way, providing access to the functionality of the player 110 does not provide access to the internal firmware and/or software running on the player 110. This reduces security risks associated with pirating audiovisual content. By providing access to the secure module 114 of the player 110, the player 110 can provide network providers and content distributors access to the player's functionality, enabling the providers to design applications to run on the player to take advantage of the capability of the player 110 and/or the infrastructure of the content delivery network 100.

The access module 112 can be configured to operate within a gateway environment that is separate from the secure environment operating within the player 110 (e.g., separate from the environment of the secure module 114). The access module 112 can comprise an application that resides within the player hardware, providing access to commands and functionality of the player 110. This provides third-party content providers as well as independent distributors access to the access module 112 via APIs or other connected servers. For example, a content delivery network provider can have one or more servers that access the player 110 through the access module 112 and a different entity can issue commands to the player 110 through the servers of the content delivery network provider by way of the connection to the access module 112 of the player 110.

The player 110 can include a playback module 116 configured to display an audiovisual asset. The player 110 can be implemented as a standalone device, such as a set-top box, which includes connectivity to a display device, such as a television or computer monitor. Connectivity can be accomplished through wired (e.g., HDMI cables, USB cables, etc.) or wireless means (e.g., wireless display (“WiDi”), wireless network, (“WiFi”), BLUETOOTH®, etc.) and can be unencrypted or encrypted. The player 110 can also be implemented as a part of a display device, such as a television. For example, the player 110 can be implemented utilizing hardware, software modules, firmware, or any combination of these in an environment within the display device. Such hardware can include, for example and without limitation, application-specific integrated circuits (“ASIC”), field programmable gate arrays (“FPGA”), micro-processors, controllers, erasable programmable read-only memory (“EPROM”), any combination of these, or the like.

The content distributor 105 includes an encoder module 120 configured to prepare, convert, and/or encode audiovisual assets. The audiovisual assets can be received from the asset server 115. Encoding audiovisual assets can include compressing audiovisual content according to any open or proprietary encoding and/or compression algorithm. In some embodiments, the audiovisual content can be encoded to have a bit-rate that is at least about 5 Mbps and/or less than or equal to about 30 Mbps, at least about 7 Mbps and/or less than or equal to about 20 Mbps, at least about 10 Mbps and/or less than or equal to about 25 Mbps, or less than or equal to about 10 Mbps. In some embodiments, these bit-rates are achieved for an output video file having at least 4K resolution.

The content delivery system 100 includes a license module 130 configured to assign restrictions on access to the audiovisual assets generated by the encoder module 120. In some embodiments, the license module 130 receives a license associated with an audiovisual asset from the asset server 115. The license module 130 can modify this received license to add restrictions to the restrictions provided in the original license. The license module 130 can use functionality provided by one or more systems in the content distribution network 105 to impose access controls on the asset. The license module 130 can impose access restrictions that are general in nature (e.g., those that apply to any player attempting to access the asset) or targeted in nature (e.g., access controls specific to a player 110 or a plurality of players). One such access control can be limiting access to the asset during a period of time, after which access to the asset expires. The duration of access can depend on a payment from a user, so the license module 130 can create a unique license based on the interaction with a player 110. The license can be distributed along with the audiovisual asset or it can be distributed separately from the asset. The license module 130 allows the content distributor 105 to provide its own digital restrictions management (“DRM”) delivery platform.

The encoder module 120 can also be configured to encrypt the audiovisual asset and/or the license using symmetric or asymmetric keys. The encoder module 120 can sign the license so that the audiovisual asset and the license are associated with the content distributor 105 and to increase security against piracy of the content. Once the asset is encoded and the license has been created, another content distributor 105 in the content distribution chain can alter the license to add restrictions on access to the asset, as described in greater detail herein.

The content distributor 105 includes a key module 140 configured to encrypt the license created by the license module 130 and/or assets created by the encoder module 120. Encryption of the asset, signing of the license, and/or encryption of the license can occur on the key module 140. The key system can generate asymmetric keys (e.g., a public and private key pair) or symmetric keys for the purposes of encrypting the asset and/or license. The appropriate keys can be distributed to the players 110, distribution server 150, other content distributors in the distribution chain, and/or the asset server 115 for managing access to the unencrypted asset and license. This can allow for the content distribution network 100 to deliver assets to systems within the content distribution network 100 without granting unauthorized access to the asset. This can allow for a content distributor 105 to distribute an asset on physical media without granting unauthorized access to the asset. When a player 110 requests to play an asset, the key and/or license can be delivered to the requesting player such that the requesting player can decrypt the license and key, check the access restrictions, and decrypt the encrypted asset. If the access restrictions are not satisfied or if the encryption key is not present, the player cannot gain authorized access to the asset. For example, when an asset on a storage disk is ingested in a player, the player can contact the key module 140 to retrieve the associated license which may authorize the player to access the asset. Authorization can include checking the player's credential against the license.

The content distributor 105 includes a distribution server 150 configured to distribute encoded assets, licenses, and/or encryption keys. The distribution server 150 can be configured to utilize API commands to communicate with the access module 112 on the players 110 to control aspects of the players 110 and/or to establish one or more players 110 as nodes within the network of the content distributor 105. This can enable the content distributor 105 to utilize the players 110 as seeds for audiovisual assets by controlling the players 110 to share audiovisual assets through peer-to-peer file sharing protocols (e.g., BitTorrent, Gnutella, FastTrack, etc.).

Using the systems and components in the content distribution network 100, a content provider or content distributor 105 can provide audiovisual assets to network connected players 110. Content distributors 105 can create their own content delivery networks and digital restrictions management (“DRM”) delivery platform to interface with the access module 112. A software development kit (“SDK”) can be provided that includes an API library and license closing tool to manage restrictions for any asset encoded and encrypted with the content distributor's DIRM identification.

### Rights Management Tools

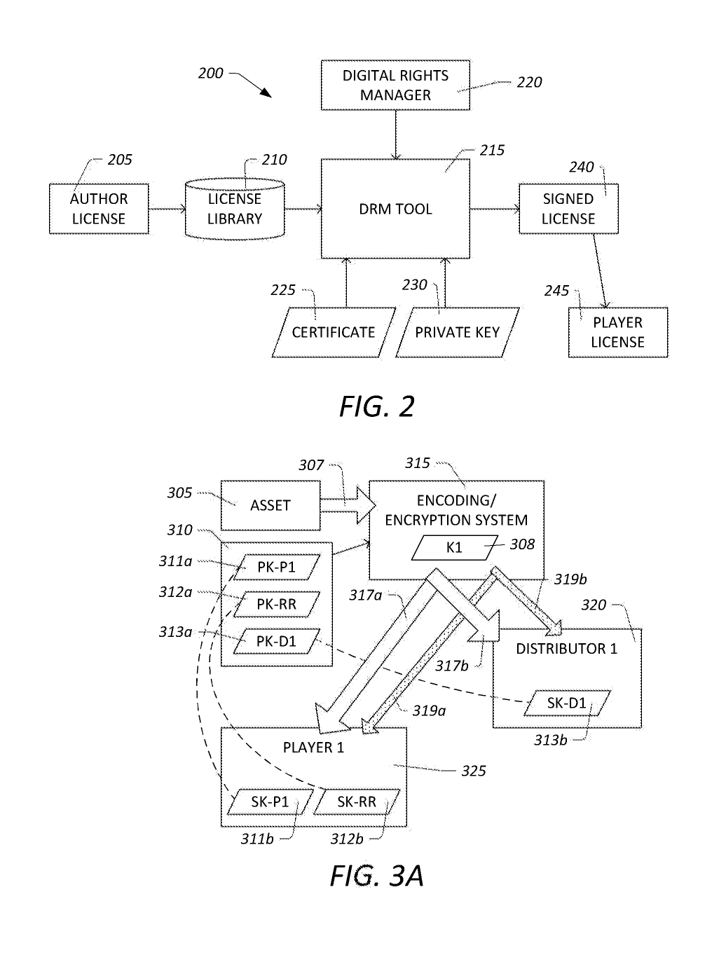

FIG. 2 illustrates a block diagram of an example rights management tool 200 configured to provide a secure license 240 associated with an audiovisual asset. An author license 205 can be provided from a source of an asset. The license 205 can be stored in a license library 210 for later and convenient retrieval. The license can be sent to the DRM tool 215 which can add restrictions from a digital rights manager 220. Upon updating or modifying the license, the DRM tool can sign the license using the digital certificate 225 and encrypt the signed license using the private key 230. The signed license 240 can be then transmitted to the player where it is checked as a player license 245 to allow access to an associated asset.

This can allow generating licenses by a distributor, and includes examples of the various files involved in this process. When the author of a project uploads it to a content distributor for distribution and licensing, the encoding software package used (e.g., the authoring tool) automatically produces and delivers an author license, which gives the Content Distributor permission to distribute the material and sell the rights to play it.

This author license, once received by Content Distributor, can be stored in a database for subsequent use when needed. Content Distributor responds to a user purchasing the right to view a movie on a particular player by creating a new license, derived from this stored author license for the selected material, but adding more restrictions (such as locking it to a particular player and time window). A DRM tool (which may be provided by the provider of the authoring tool) produces this new license, if fed the appropriate input data: the author license for the selected material, a list of additional restrictions, content distributor's certificate and private key (for signing).

The output of the DRM tool is the desired license with the specified restrictions, signed by the content distributor. This new license is suitable for sending to the player associated with the license. Later, when the operator of the player attempts to play the content, this license will enable decryption and playback, if all of the restrictions embedded within the license are satisfied.

This restrictions file is created by the content distributor's software for each license it generates, and is fed to the DRM tool in order to provide the appropriate playback restrictions that should be embedded in the license it produces.

The exact restrictions selected will be determined by the Content Distributor, and will depend on agreements with the content owner and the end-user purchase. If the author license specifies multiple playlists, then the DRM tool supports specifying a restrictions list for each playlist individually. This enables the Content Distributor to provide differing restrictions for each.

### Example Rights Management, Tools

In some embodiments, a shared API library that allows third-party participation with a player through access to the access module can be provided. The library can include commands and routines that can be used to close the open license that is issued to a content partner for each asset created with the encoder. This can allow the third-parties to apply further DRM restrictions via a network infrastructure.

In some embodiments, a content or network provider can use this shared API library to access a mechanism to close the open license. These transaction-specific restrictions can be sent to and interpreted by the access module. In some embodiments, the shared library is adapted to run on a variety of operating systems including UNIX, Linux, Windows, Mac OSX, Cent OS, and the like.

In some embodiments, the shared library API can be configured to accept as input information that can be used to create a restrictions.xml file to modify an open license. The inputs can include a player ID; a content provider key (e.g., an open license signed to the provider and to be closed by the provider); and an XML List which can be used by the player to execute commands and which the module unpacks and passes to the secure operating environment of the player via a defined API. The XML List can include, for example, a UUID of content, a lifespan restriction (e.g., dates where the asset is not valid before and/or not valid after), acceptable or allowable dates/times of play, date restrictions within a valid date range which can negate an old license, playlist creation and execution, chunklist authorization, maximum play count, region, and other limitations. In some embodiments, the restrictions are verified by the access module. In some embodiments, the restrictions are verified by the access module and/or the player in the secure operating environment (which can be limited, for example, to start date and time, end date and time, PIN number, and/or number of plays count). In some embodiments, some checks can be considered soft checks which are required to be backed up by hardware-based checks.

The shared library API can be configured to have the following outputs: an encrypted package or a closed license; a restriction file which can include a content partner's closed license which in some instances is not encrypted. In some embodiments, a closed license will contain the original open license and all the new restrictions created.

The access module can be configured to process commands from the shared library API and to parse the information to provide API gateway commands to the secured operating environment to control the player, command the storage, and/or distribute secondary restriction inputs to the hardware. In some embodiments, the share library API in conjunction with the access module can be configured to provide analytics, decision lists for when/if a license is sent, disk management of provider-tagged assets, player control from the network, content ingest solutions (e.g., content delivery through a CDN, peer-to-peer methods, through physically attached storage, etc.).

The content delivery network and the supplied API commands can be used to close open licenses created using the encoder. A closed license can contain the original license and any new restrictions created. In some embodiments, a closed license can be unmodifiable, and modification would invalidate the license. In some embodiments, the licensing tools and commands are not used to verify the restriction list created by the content provider. The access module is configured to receive the closed license and the access module can be configured to verify the restrictions list. In some embodiments, the access module can be configured to add the asset and license to the player and the player can be configured to authenticate the license and enforce a limited list of restrictions at the hardware level. In some embodiments, the access module and player can be configured to verify whether the asset is playable during transport control events (e.g., play, pause, stop, etc.).

### Example Distribution of Encrypted Assets

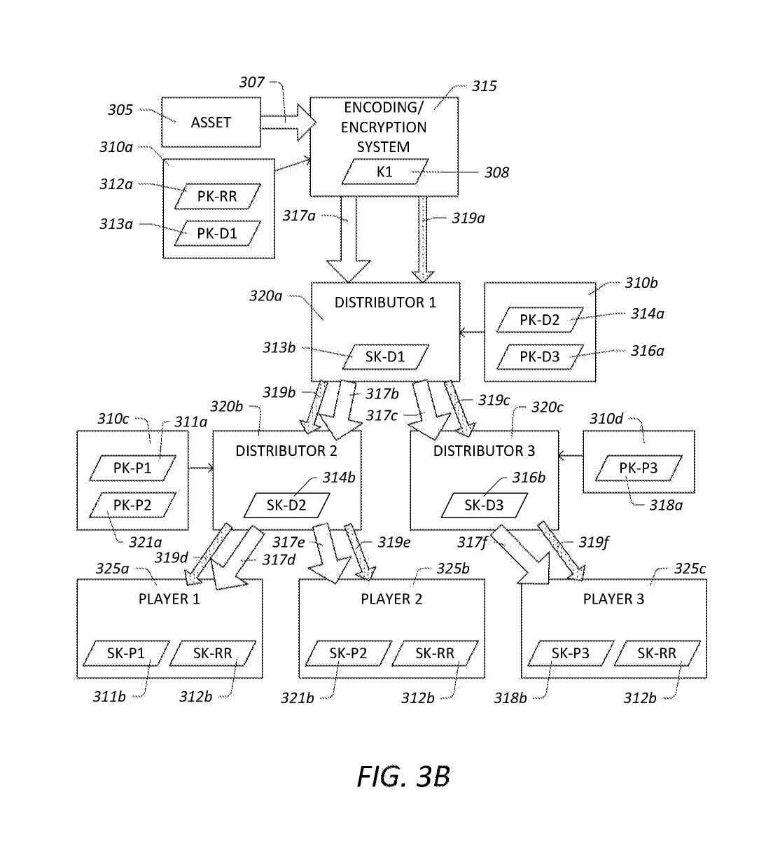

FIGS. 3A and 3B illustrate block diagrams of example distribution chains which encrypt audiovisual assets, licenses, and encryption keys. The encoding and encryption process is similar whether the intended recipient of the content is a specific player (represented above as Player 1 325) or a content distributor (represented above as Distributor 1 320) who will later deliver the content to one or more players based on DRM license playback rules defined in the distribution agreement with the content owner.

The encoding system 315 can generate encoded video files from the asset 305 which is transmitted 307 to the encoding system 315, with selectable, targeted, defined, or desired encoding parameters. The encoding system 315 can generate a unique ID associated with the encoded content for identification purposes. The encoding system 315 can generate a secret key K1 308 to encrypt the content. The key K1 308 can be encrypted using a global player public key PK-RR 312a followed by encryption with a public key PK-D1 313a and/or PK-P1 311a of an intended recipient. The public keys can be stored in a key database 310.

The encoding/encryption system 315 can transmit the encrypted asset 317a, 317b to the respective player 1 325 and distributor 1 320. The encoding/encryption system 315 can transmit the encrypted key and/or license 319a, 319b to the respective player 1 325 and distributor 1 320. The distributor 1 320 can use its private key SK-D1 313b to decrypt the last wrapper of the encryption with PK-D1 313a by the encoding/encryption system 315. Similarly, the player 1 325 can use the global player private key SK-RR 312b along with its private key SK-P1 313b to decrypt the license and secret key K1 308. Using the secret key K1 308, the player 1 325 can then decrypt the asset 305.

In some embodiments, the encoding system 315 can be configured to provide 2-pass variable bit-rate video encoding and encryption of video and 2-pass variable bit-rate encoding and encryption of 7.1 channel audio using, for example, HD-AAC codec. The encoding system 315 can be configured to provide 2-pass variable bit-rate video encoding and encryption of video and 1-pass constant bit-rate encoding of stereo audio using, for example, AAC codec. The encoding system 315 can be configured to provide pre-encode crop and scaling of source files. The encoding system 315 can be configured to provide noise reduction techniques. The encoding system 315 can be configured to create a variety of output file types including, for example and without limitation, .mov QuickTime compatible H.264, .mp4 non-QuickTime H.264, and/or any other proprietary output file format. The encoding system 315 can be configured to encrypt media files (e.g., video, audio, subtitles, etc.) using AES128. The encoding system 315 can be configured to support public/private key encryption, for example, using a player identification number (e.g., a 9-digit player ID or PIN). This can be used to restrict playback to the player with the appropriate identification number.

FIG. 3B illustrates a similar encryption and distribution chain with additional levels of distribution. The chain includes additional distributors 2 and 3 320b and 320c, with corresponding public keys PK-D2 314a and PK-D3 316a and private keys SK-D2 314b and SK-D3 316b. The distribution system also includes additional players 2 and 3 325b, 325c with corresponding public and private keys SK-P2, SK-P3 and PK-P2, PK-P3. Each player has a copy of the global player private key SK-RR 312b. In such a system, the asset 305 is encrypted through every link in the distribution chain. Each distributor can receive and transmit the encrypted asset without decrypting and/or encrypting the asset themselves, reducing costs and burdens on the distributors. Multiple distributors can be present in the chain. Also, the asset can be encrypted with the same secret key thereby making one encrypted copy which can be saved and distributed from one or more locations, saving on storage and computation. It should be noted that content and licenses may be distributed separately and at different times.

Public keys can be generated and disseminated to appropriate links in the chain through a registration process. Thus, each link in the chain can have access to the intended recipient's public key to allow secure transmission of licenses and secret keys.

In some embodiments, content can be broadcast to multiple players by encrypting the secret key K1 312b using only the global player public key PK-RR.

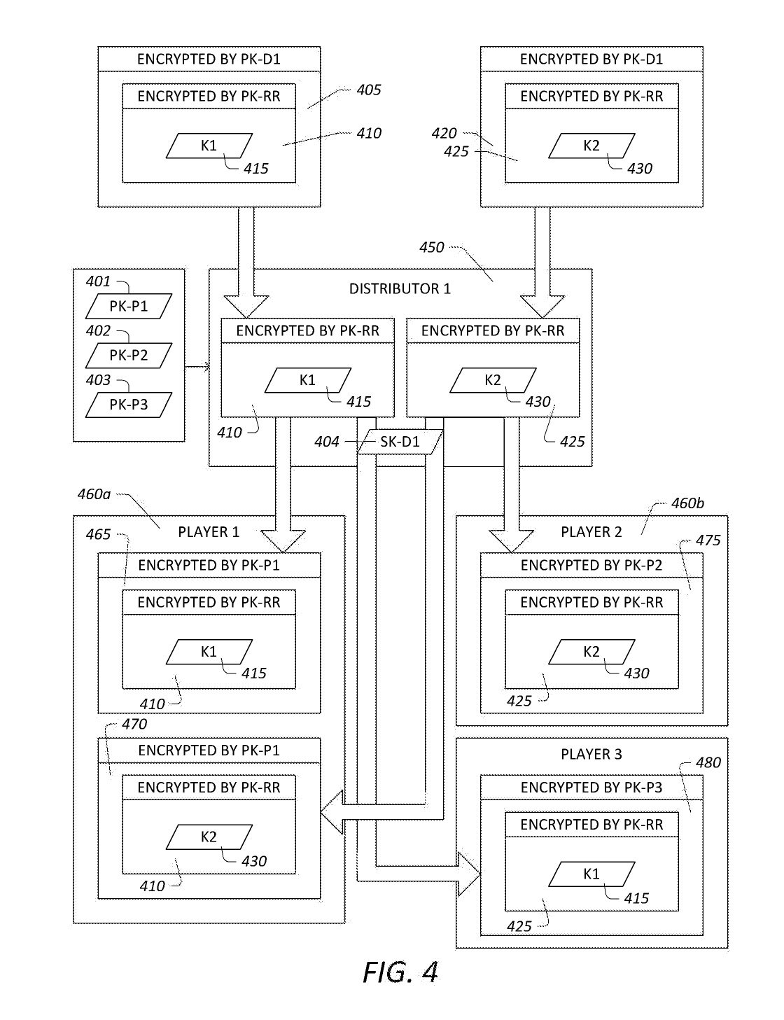

FIG. 4 illustrates a block diagram of multiple layers of encryption configured to limit access to an asset encryption key. Content keys K1, K2 can be encrypted one or more times and are not generally fully unwrapped or decrypted until they are delivered to the target playback device. Because only authorized devices contain the global player private key SK-RR, a content distributor does not generally decrypt the content keys K1, K2. As illustrated, an upstream entity that delivers the keys to the distributor encrypts the messages using the distributor's public key PK-D1. This allows distributor 1 to unwrap one layer of the encrypted content and then re-wrap the encrypted content in an encryption using an intended recipient's public key.

A first content key K1 415 can be encrypted using a global public key PK-RR, creating a first encryption envelope 410. This first envelope 410 can be further encrypted using an intended recipient's public key, which in this case can be PK-D1, corresponding to distributor 1 450. This generates a second envelope 405. Similarly, a second content key K2 430 can be encrypted in two envelopes 420, 425 using the same public keys. These encrypted envelopes 405, 420 can be transmitted to the distributor 1 450 which can use its private key SK-D1 404 to unwrap the outer envelopes 405, 420. The distributor can then generate another exterior encryption envelope for each intended recipient player, which entails creating the envelopes 465, 470, 475, and 480 using player 1's public key PK-P1 401 for envelopes 465 and 470, player 2's public key PK-P2 402 for envelop 475, and player 3's public key PK-P3 403 for envelop 480. Although not illustrated here, it is described herein that each player has corresponding private keys and a global private key SK-RR to allow full unwrapping or decryption of the content keys K1 415 and K2 430. This can allow players to decrypt corresponding assets encrypted with the symmetric content keys K1, K2.

Audiovisual Player with a Gateway Environment and Secure Environment

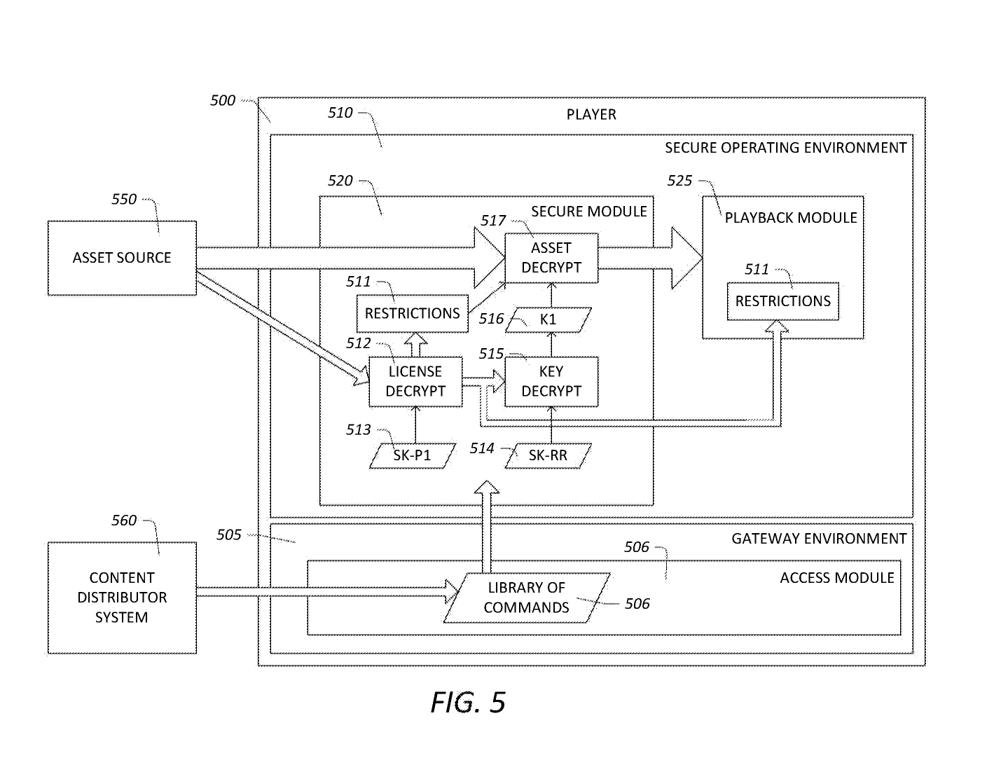

FIG. 5 illustrates a block diagram of an example player 500 having a gateway environment 505 with an access module 506 and a secure environment 510 in communication with the access module 506 through a library of commands 508.

The player 500 can receive an asset and license/key from an asset source 550 (e.g., local storage or over a network). The player can include a secure module 520 operating within the secure environment which can decrypt the asset and license received from the asset server. The license can be decrypted using the private key SK-P 1 513 in the license decrypt module 512. This can allow the player 500 to extract restrictions 511 which act to limit access to the asset. Upon decryption of the license, the asset key can be decrypted in the key decrypt module 515 using the global private key SK-RR 514. This allows the asset key K1 516 to be revealed and used in the asset decrypt module 517 to decrypt the asset. The asset decrypt module can check the restrictions 511 from the license to verify the player 500 is allowed to access the unencrypted asset. Once decrypted, the asset can be passed to a playback module 525 which generates an audiovisual data stream corresponding to the asset. In some embodiments, the playback module 525 checks the restrictions 511 to verify that the player is permitted to generate the audiovisual data stream. In some embodiments, the generated audiovisual data stream is dictated by the asset, such as through one or more playlists present in the asset, as described herein.

The player 500 may be designed as an IP network AV server configured to receive, cache, and/or decode videos encoded in .MP4 (e.g., 720 p, 1080 p), .RED (e.g., 2K or 4K) or .R3D (e.g., 4K, 5K, 6K) file formats, for example. Files may be received over Ethernet or 802.11 wireless links, on USB, SSD, SD or CF media, or read from internal SATA or external USB, FireWire or SATA based storage, for example and without limitation. Video playback could be progressive scan or interleaved, and can include resolutions ranging from 480 i, to 720 p, to 1080 p, to 4K, to 10K. The player 500 can be configured to provide RGB image processing and monitoring; RAW to RGB conversion; video and audio outputs via HDMI; video and audio monitoring outputs via HDMI and/or RCA; internal SATA media port empty or with SSD or other storage device; USB, FireWire 800 and/or e-SATA external storage ports; gigabit Ethernet network/control/key exchange interface; download of media to internal memory or attached storage; 7.1 channel 24-bit 48 kHz LPCM surround sound output; remote control from, for example, RF4CE wireless controllers, iPad, laptop, smartphone, or other 802.11 WiFi device; and digital rights management. The player 500 can be configured to support up to 4K resolution RGB or 4:2:2 video, via four HDMI 1.3 connectors, each operating at up to 2K resolution. The player 500 can be configured to support 8 or fewer channels of 24-bit 48 kHz uncompressed LPCM audio on an HDMI 1.4 connector, and two channel analog mix down at consumer line level (−10 dBv) on RCA connectors. The player 500 can be configured to provide instant play capability as soon as enough media has been cached to memory. For an encrypted media file (e.g., with DRM), the file may be decrypted in real time during playback.

The player 500 can support a secure boot, executing authentic firmware signed by an authorized source. This can defend against a possibility of altered code being run on the player and can allows for a secure setup of the API that controls access to the security services in the system.

Encoded content can be fed into the system (through a local drive or over a network, for example) in an encrypted form. The system can be configured to extract the content key for decryption which can be transferred to the decryption module, to decrypt the content and send it to the playback module in real time.

A request by a user to play back content can result in the player 500 requesting a license which is valid for the combination of the asset's identification and the player's identification. The license can be downloaded to storage or through the network.

Once a license is obtained for the requested content and player combination, it can be authenticated to exclude false DRM licenses that would permit unauthorized rights. Authentication of a license involves verifying its signature. The public key of the specified signer is used to turn the signature into a hash, then that value is compared against the computed value of the hash of the DRM license. A match can indicate that the signature is authentic. A DRM license can be signed directly by the DRM provider or by an approved content distributor. The public key or digital certificate from the content distributor, stored on the player 500, can be used to perform license authentication on the player 500. To guard against tampering of certificates, they can also be signed (and so authenticated). This process of authenticating a signature, and then repeating the process on the signer's signature (and so on) can be referred to as a “signing chain.” The signing chain can lead back to a root of trust, which can be a root public key present on a player. This can provide a hardware mechanism that allows the player 500 to trust all the nodes in a properly signed certificate chain, and therefore to trust the DRM license found at the top of the chain.

Once a DRM license has been authenticated, the rights within the license can be checked against the action requested. This includes checking one or both of allowed first and last play dates/times, and allowed maximum number of play-outs. If multiple licenses are found for a combination of player identification and asset identification, each license can be authenticated and read, as they may provide varying levels of permission on different dates.

Once it has been verified that playback of a piece of content is permitted by a DRM license, the content key K1 embedded with the license can be extracted. This may be accomplished by decrypting the content key K1 using the private key SK-P1 of the specific player, followed by decrypting using the global private key SK-RR.

### Example Gateway Command Set

The following commands can be used to communicate with and control a content manager or access module on a player over a network. The access module can be configured to support a variety of commands which trigger actions on the player. For example, the access module can be configured to support a discovery command configured to utilize a user datagram protocol (“UDP”) broadcast for discovery purposes. The module can be configured to support an acknowledgement command, wherein the acknowledgement includes an internet protocol (“IP”) address of the player and a Player ID Port. The access module can be configured to support a register command which includes a public key, session key (with an associated timeout), event data, and that is configured to encrypt and register a connection into the player. The access module can be configured to support an information request, where information can include a PIN number of the player, the player's current state, a player ID, a player port, a player name, system information, disk or storage information, CPU information, memory information, and content information. The access module can be configured to support a change of state set of commands which can include, for example, play, pause, stop, rewind, forward, load, etc. The access module can be configured to support a content manager set of commands which includes list content, provide content information, provide UUID details of assets, add an asset, read an asset, write an asset to disk, etc. The access module can be configured to support a set of display commands that include a request to display information on screen (e.g., display up to about 128 text characters in an on-screen display) and/or display information on a connected device (e.g., display up to about 128 text characters in an iPad or other similar tablet device or smartphone).

### Example Access Module Commands

Accessing and playing an asset on a player can include several APIs. Access and playback of an asset on the player can be accomplished through a remote control and/or through a device connected to a common local area network with the player. In order to playback assets, the player or access module can be configured to query a license system regarding the player's status of rights in relation to the asset. For example, the player can query the access module to check to see if an asset is validated and authorized when requested on the player through the use of a remote control or network-connected controller. When an asset is added via a mass storage device (e.g., physically ingested), the player can decide whether to accept or reject it. During ingestion, the player can be configured to display information about ingest progress.

### Example Use Cases

An example of physically ingesting an asset can include a user inserting an asset on a USB device in the player. The matching license may be on the asset server. The access module displays a “Load Console” on the display. The OSD asks for confirmation—select ‘YES’, I want to add this movie to my library.

After it finishes writing the Asset to the disk, the access module will get an ‘event’ from the player firmware, confirming the addition. The access module will check if the asset simply requests its matching key, which could have been generated as a player-specific key or open. Or, if the asset is created in an encoder module by encrypting to a content distributor's DRM, then the access module will check back to the server to see if a license, associated with that asset is also associated with that player.

If there is, the access module will download it, if there is not a player associated license, the access module will leave it as is and if there is an attempt to player that movie, the User will get and error (OSD) indicating they need to buy authorization to view that movie.

If a matching license for that asset and for that player exists, then the access module will download it into the access module environment which will pull everything from the server and pass commands to the player and it will start playing.

Access module can be communicating with its home datacenter and will even check as it's playing.

An example of network ingest will now be presented. A content distributor's end-use customer with a player (that has been registered on their system), is browsing online through the distributor's catalogue, and they notice that a movie has a tag saying ‘this movie is already on your player,’ via the pre-seeding process.

The access module can be configured to provide a response. The access module can talk to the content partner's server. When the system says, ‘download this movie,’ the access module starts to pull the asset into the player. As downloading begins, the access module tells the player content manager, ‘write this,’ ‘write this,’ ‘write this,’ etc. as it regards the chunks associated with the movie, until it has been downloaded to an acceptable size, (e.g., a partial or entire movie).

Once it has been downloaded, it gets added to the library. The player is now aware that they have it and the access module will again communicate from the partner's server (based on a purchase transaction) and grab the license.

Once the license is applied, the access module will also communicate with partner's server to say this movie is available for viewing immediately.

Even in the case of USB ingest, the access module can call home to alert the associated user account that an asset is on the player whether it has been pre-seeded by a content provider or added locally.

In such cases, the user can be displayed two icons on any given movie as they browse the content distributor's catalogue. First, they can be shown if an unauthorized asset is already on the player thus requiring only a purchase and small authorization package to be downloaded, and secondly, they can be shown if an already authorized asset is ready to play immediately.

A case of partial ingest will now be presented. In some embodiments, a movie can be ingested partially over the network and partially through local data storage. In such cases, the access module can begin by reading the chunklist and playlist associated with the package structure. The access module can then communicate to the content partner's server and download the missing chunks associated with the package definition.

### Example Content Delivery Network Using Access Modules

The access module can be configured to respond to a defined command set, in the form of API gateway commands that are sent from a software environment (e.g., a Java Virtual Machine environment) on the player, to the player's secure firmware environment. These commands can be specially-defined binary commands. In some embodiments, the commands do not utilize the RCP protocol.

In some embodiments, the command set can be provided utilizing an SDK which allows a content delivery provider to manage their own programs, separate from the provider of the player software environment. This can allow providers to improve or optimize communication with players on their network utilizing access modules that are created by the providers. In some embodiments, the providers can design access modules that provide local management of licensing and manage progressive downloads from the content provider's network.

### Asset File Formats

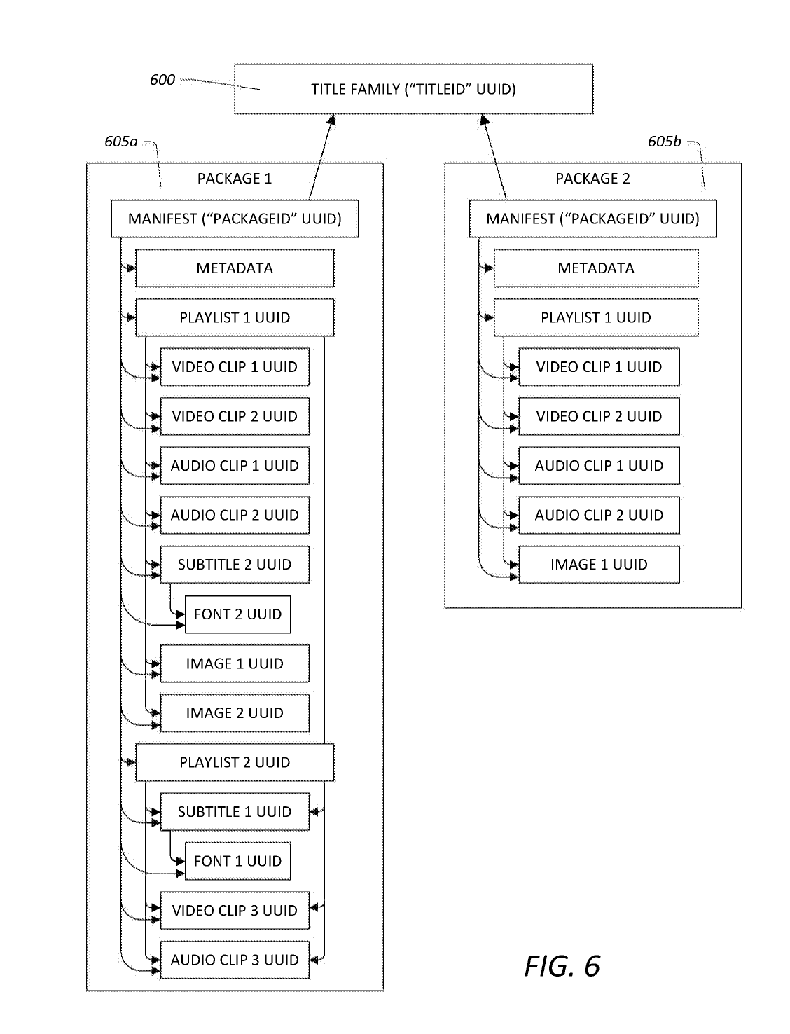

FIG. 6 illustrates an example file format associated with an audiovisual asset which includes a plurality of packages 605a, 605b each with one or more playlists. Material intended for playback may be formatted into a structure of multiple files, with those files in specific formats. Automated authoring tools can be used to author material into a compatible format.

A package 605a, 605b is a related collection of all files necessary for playback of one or more presentations. Multiple packages can be prepared that relate to the same project (for example, different language localizations of the same movie). To tie these related packages together, each package contains a TitleID value. Related packages should all refer to the same parent title, by having identical TitleID values. Note that there is no actual file for the Title Family 600. Most files in packages have identifiers that specify the package (PackageID) and title (TitleID) to which the file belongs.

The manifest is contained in a package 605a, 605b, and can be configured to represent the head of the package and provide its identity, to itemize other files that should be present in the package and the UUID for each, to provide information to authenticate other files in the package, and to be signed by the package creator.

To permit integrity checking of the package and detect tampering or other package damage, the manifest can be signed by the content creator, using the authoring tool. A verified signature can ensure the contents of the manifest are correct. Since the manifest can also include the hash digest of other assets in the package, then those assets can be authenticated as well.

Metadata in the package 605a, 605b can represent data associated with a movie or audiovisual asset. This file can be included in the list of assets in the manifest, but its hash and size may not be recorded there. This allows a content distributor to provide value-added metadata at the behest of the content owner, after the package has already been authored and uploaded to the content distributor. Because the integrity hash for the metadata file is absent from the package manifest, the metadata file must be signed by the content distributor so it can be authenticated.

Each package can include one or more playlists. Each playlist can be presented to the user as a playable object, and therefore must be given a title that makes it clear to the user what material the playlist presents. Each playlist contains multiple tracks, one each for video, audio, and subtitles (if present).

Each playlist may contain all the information needed to play a complete presentation, using other assets in the package as building blocks. For example, audio, video, and subtitles are stored as separate clips. In some cases, each track may be broken into multiple clips. The playlist contains the references to the proper files, including the timing information to allow presentation of the material seamlessly.

Multiple edits of a movie can be presented simply by including multiple playlists. For example, a director's cut could include references to scenes that are deleted (not referenced) in the standard playlist. The authoring tool will break the material into clips appropriately to allow the playlists to assemble the required versions from the same building blocks.

As illustrated in FIG. 6, the playlists can reference multiple clips corresponding to video, audio, subtitles, and/or images. By piecing the clips together in the way the playlist indicates, multiple presentations can be created for a single asset. Similarly, as illustrated in Package 1 605a, Playlist 1 can include clips referenced by Playlist 2, allowing playlist 1 to include all the information from Playlist 1 and at least a portion of Playlist 2.

Each movie can be broken up into multiple, randomly accessible, video and audio segments (audio clips or chunks) which can be joined together under the direction of a playlist. This technique allows multiple versions of a movie to be created by delivering an original movie segment payload, alternate video and audio segments (which may include commercials), and a plurality of playlists. These elements may be delivered at the same time, or a later time as the files representing the original movie. In some embodiments, movies can be priced according to choice with respect to advertising. A pay-per-view choice yields a first price, X, a choice to allow advertising within the movie allows a second price, X−n (which may be free, as is the case in a general broadcast model).

To distribute video and audio files representing alternate versions of a movie (e.g., a theatrical cut and a director's cut), a movie may be broken up into multiple video and audio segments joined together under the direction of a playlist. Content owners could create alternate action segments, which can allow multiple ratings to be assigned to a single movie, hence increasing potential profits by allowing a movie to be targeted to audiences that desire, for example, PG-13 or R ratings, respectively. This might be achieved by replacing scenes that may include offensive language or nudity, with an alternate scene without that content. A playlist could therefore be responsible for the selection of the appropriate scenes that should be shown in order to comply with a specific rating.

In some embodiments, a DRM license could be restricted by time and rating or password combination, so that a content owner or consumer could choose to restrict which version of a movie can be shown prior to a time, e.g., allowing only the PG-13 playlist prior to 9 pm and/or only with entry of a password.

To permit advertising to match to product placement opportunities, during the movie encoding process, one or more tags may be placed at strategic locations in the movie to provide content-specific advertising opportunities. Each tag could generate, for example, an animated graphic pop up in the lower third of the screen, and point to a commercial stored on the player's internal hard drive. When a pop up is displayed, it could be selected by the viewer and movie playback could be paused while the advert is played, after which the movie could resume playback from the paused location. In certain implementations, if the viewer ignored such a pop-up, the movie could continue to play uninterrupted.

In some embodiments, a tag could call a URL (web site) or location of a streaming video service that could provide a commercial such that the commercials do not have to preexist on the player's hard drive.

To distribute alternate languages for movies, during the movie encoding process, dialog tracks could be removed from the mix, and the remaining effects tracks could be encoded as a separate mix without dialog. Dialog could then be encoded as a separate mix (possibly at a significantly lower data rate due to the spare nature of dialog across the channels) and both encoded files could be delivered to the player. On playback, the two encoded files could be decoded and remixed to re-create a combined effects-and-dialog soundtrack.

If dialog is replaced, for example, when a second or additional language(s) is added, the second dialog track file can be delivered to the player without additional language tracks. In this manner audio may be updated straightforwardly and efficiently across a network such as through a network connection (e.g., over the Internet). Additional dialog tracks may be included at the time of original movie distribution, or added as a supplementary download at a later date.

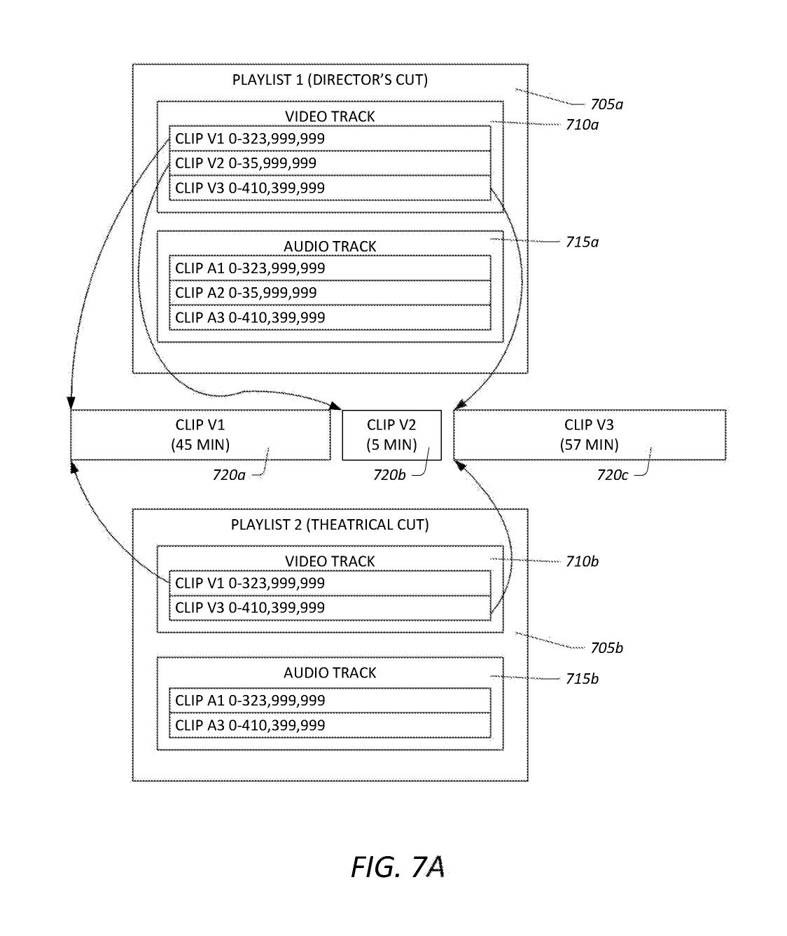

FIGS. 7A and 7B illustrate example playlist files dictating presentation of audiovisual clips associated with a presentation of an audiovisual asset. In FIG. 7A, playlist files corresponding to a director's cut 705a and a theatrical cut 705b are illustrated. The playlist files 705a, 705b include information about video clips 710a, 710b and audio clips 715a, 715b. The information included with the video clips includes a duration and starting and endpoints. Because the playlists include different clips, the audiovisual data stream generated will differ between them. For example, the director's cut 705a will play clip v1 720a, followed by clip v2 720b, followed by clip v3 720 while the theatrical cut will omit clip v2 720b.

FIG. 7B illustrates a preview playlist 705 which again contains video track information 710 and audio track information 715. However, in the preview playlist 710, only a portion of the corresponding clips is shown, such as a portion 725a of clip v1 720 and a portion 725b of clip v3. The portions and duration of the clips are indicated in the video track and audio track information 710, 715.

Portions of clips can be used in a playlist where each clip portion begins at a sync point of the clip. One way to generate the location of a sync point is using an authoring tool to begin a new clip at the location of the desired sync point.

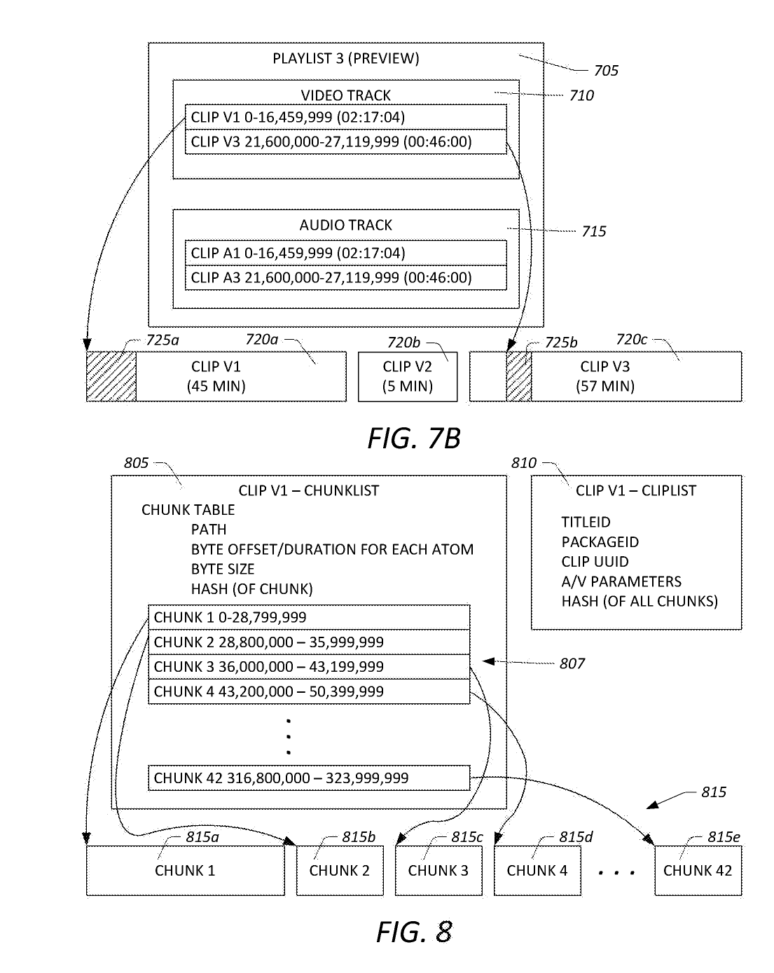

Clips can be building blocks that make up audio, video, or subtitles of a presentation. Video clips can contain a large quantity of data. To reduce storage and distribution of a package, the authoring tool can split these clips into multiple chunks 815, as illustrated in FIG. 8. For example, the video clips can be broken into various sized chunks 815.

Each video clip can have two files: a clip file 810, which can include metadata about the clip (TitleID, PackageID, Clip UUID, A/V parameters, and/or Hash of all chunks), and a chunklist file 805, which describes the chunks that make up the clip and can include a chunk table comprising, for each chunk, a file path, a byte offset/duration for each chunk or portion thereof (e.g., atom), a byte size, and a hash of the particular chunk. Other types of clips are not chunked and may therefore have no chunklist file. The chunklist file 805 can include chunk information 807 indicating a start, stop, and duration of each chunk making up the associated video clip.

In some embodiments, some of the chunks may be missing from the video clips. This situation may be desirable to conserve storage space or data delivery when portions of the clip are not yet being played. For example, when only a free preview of a movie is viewable, much of the material would not be presented during playback.

Note that the chunklist.xml still refers to the missing chunks to preserve the overall timing information. Portions of the clip that correspond to missing chunks cannot be played.

Video clips are designed to be straightforwardly transformed into a different set of chunks after authoring has already occurred using the authoring tool or another similar encoding tool.

### Delivery of an Asset and License

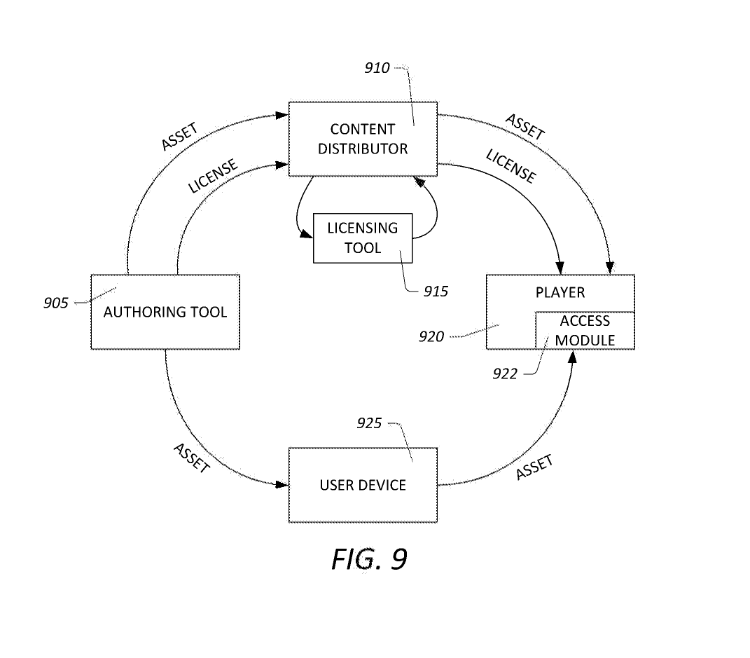

FIG. 9 illustrates a block diagram showing the flow of data from an authoring tool 905 to an audiovisual playback device 920 having an access module 922, as described in greater detail herein. An authoring tool 905 provided by an authoring provider generates a new asset, creating both an asset and a license. The license can be published to a content distributor 910. The user device 925 can also receive the asset from the content distributor's network or use an alternative transfer means.

Once the content distributor 910 has the license created by the authoring provider, it can create its own encrypted version of the license using the licensing tool 915. In some embodiments, the content distributor 910 can make modifications to add new restrictions specific to the content distributor 910, generating a new restrictions or license file that is passed back to the authoring provider, which generates a new secret public key using their own encryption.

The user can allow the content distributor 910 to seed the asset and license to the player 920, or simply transfer the asset onto the player 920. Assets can be seeded to the player, with or without the corresponding license.

A user device 925 or player 920 with an asset can now download the content distributor's version of the license (generated by the content distributor 910 or the authoring provider using the licensing tool 915) which contains the original license from the authoring provider and is then used to decode the asset at the player 920.

Now that a license is available with an asset, a movie can be played. The access module 922 can be configured to decode the content distributor's version of the license, removing the authoring provider's license and add it to the content manager. On play, the access module 922 can be configured to verify authority of player 920 to play the movie asset.

The access module 922 can be configured to attempt to read the restrictions in the license, and validate everything to be correct. When playback occurs, the player 920 can be configured to verify the license to allow playback of the movie.

### Securely Distributing and Playing an Audiovisual Asset

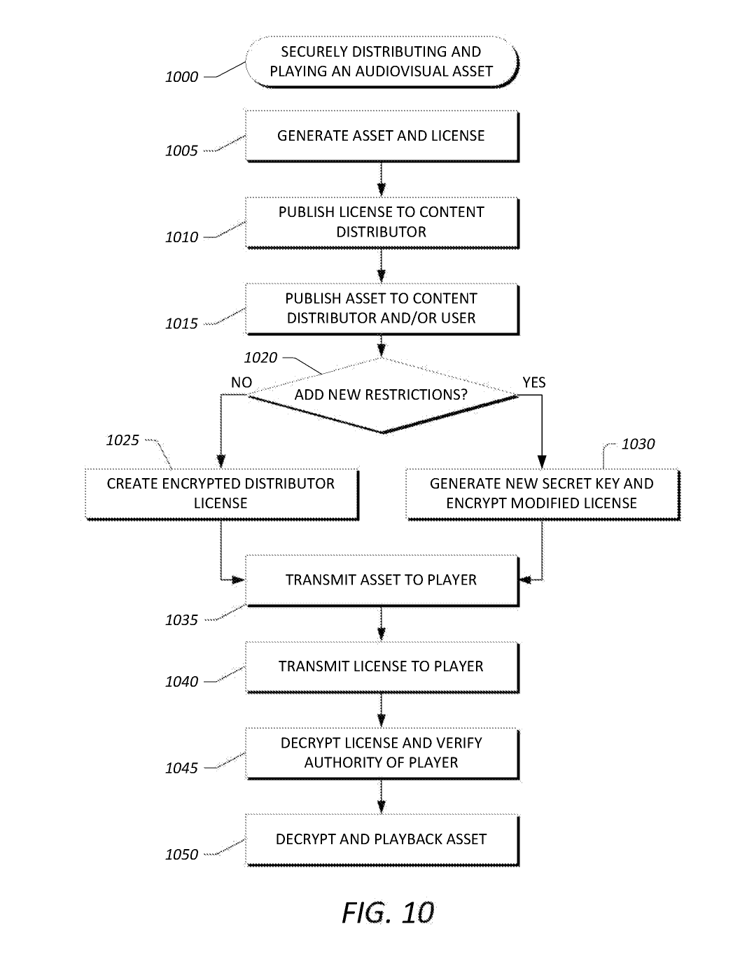

FIG. 10 illustrates a flow chart of an example method 1000 of securely distributing and playing an audiovisual asset. The method can be performed by any appropriate module or system or combination of systems and modules described herein.

In block 1005, an asset and license are generated. This can be done by an asset author, such as a movie studio. In block 1010, the license can be published to a content provider. The license can include playback restrictions to which the content distributor can add restrictions in block 1020. If restrictions are added, an authoring tool can be used to generate a new secret key and encrypt the modified license in block 1030. If restrictions are not added, the content distributor can create an encrypted distributor license in block 1025. The asset can be transmitted to a player in block 1035. In block 1040, the original or modified license can be transmitted to the player. The player can attempt to decrypt the license and verify the authority of the player to access the asset in block 1045. If access is authorized, the player can decrypt and playback the asset in block 1050.

### Playing an Encrypted and Licensed Audiovisual Asset

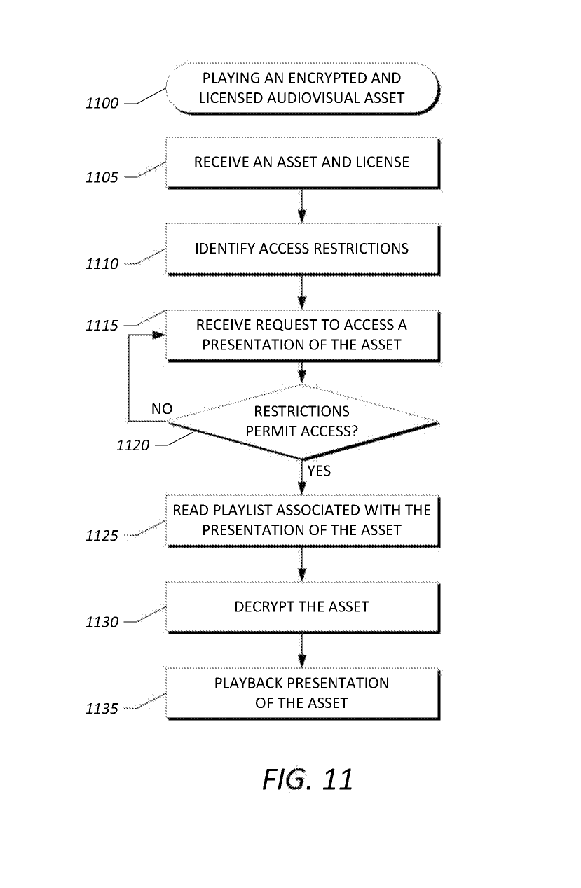

FIG. 11 illustrates a flow chart of an example method 1100 of playing an encrypted and licensed audiovisual asset. The method can be performed by any appropriate module or system or combination of systems and modules described herein.

In block 1105, a player receives an asset and a license, which both may be encrypted. The asset can be encrypted using a symmetric key. The license can be encrypted with multiple levels of encryption using public keys resident on the player.

In block 1110, the player identifies access restrictions which can include decrypting the license and reading the associated restrictions in the license file.

In block 1115, the player receives a request to access a presentation of the asset. This can include a user generating a request to watch a particular version of an asset, such as a director's cut of a movie. This can also be initiated by a third-party with authorized access to the player through the use of API commands sent to an access module present on the player.

In block 1120, the player checks whether the player has access to the requested presentation by checking the access restrictions in the license. If access is denied, the player waits for another request to access a presentation.

If access is granted, the player reads a playlist associated with the requested presentation of the asset in block 1125. The playlist can comprise a file which lists a series of audiovisual clips to present which, when presented in the order dictated by the playlist file, provides the requested presentation.

In block 1130, the player decrypts the asset using the decrypted content key delivered within an encrypted envelope, as described in greater detail herein.

In block 1135, the player generates an audiovisual data stream to deliver to a display device, such as a television or computer monitor. In some embodiments, the player is incorporated into a television and the audiovisual data stream is provided directly to the appropriate display circuitry for display rather than being transported over cables (e.g. HDMI) or wireless (e.g, WiDi).

### Licensing an Audiovisual Asset

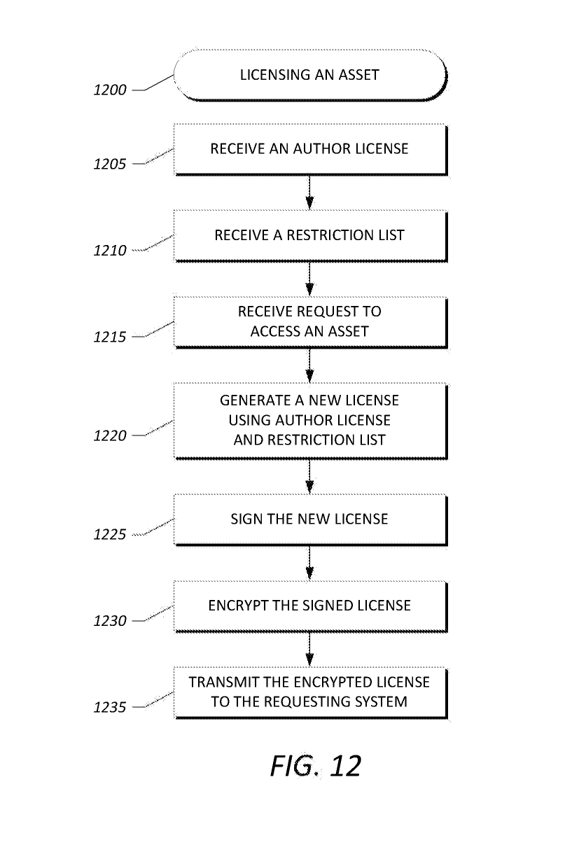

FIG. 12 illustrates a flow chart of an example method 1200 of licensing an audiovisual asset. The method can be performed by any appropriate module or system or combination of systems and modules described herein.

In block 1205, the license tool receives an author license associated with an audiovisual asset. In block 1210, the license tool receives a restriction list to add to the author license. In block 1215, the license tool receives a request to access the asset associated with the modified license. In response to the request, the author license is modified to include the restrictions creating a modified license in block 1220. In block 1225, the license tool signs the license with a digital certificate or encryption key, as described in greater detail herein. The license tool encrypts the license with two layers of encryption, the first being accomplished using a first asymmetric key corresponding to a global private key present on authorized players, and the second being accomplished using a second asymmetric key corresponding to a private key present on an intended recipient system, which can be another distributor in the chain or a player requesting access to the asset. In block 1235, the encrypted modified license is transmitted to the requesting system.

### Example Asset, and License Creation Engine

As described herein with reference to FIG. 1, the network 100 can include an encoder module 120. The encoder module 120 can be used to provide metadata tags in the asset at the point of encoding. The encoder module 120 can take video and audio source files and output a content package with an open license (generated by the license module 130) assigned to a particular content provider or content distributor 105. The asset can be configured to be inaccessible to players on the network through this open license. The open license, for example, can be configured to not include any access restrictions but due in part to its status as an open license, no license module 130 or key module 140 would grant access to the asset when requested by a player 110. In some embodiments, a content distributor 105 can detect whether a license is open by reading the XML restrictions from this license, and can choose to reject the license. In some embodiments, the open license can be tagged for a particular content distributor 105 or network provider such that other entities cannot access the assets created with the encoder module 120. The open license can be delivered to the network or content distributor 105 and access restrictions can be assigned at a later time, such as at the time of transaction with a player requesting access to the asset.

The encoder module 120 can be configured to accept as input sequential 16-bit TIFF, or 10-bit log DPX; 48 kHz 2 5.1 channel WAV files; video at about 24 fps or 23.98 fps; and/or select provider DRM options. The encoder module 120 can be configured to output a universally unique identifier (“UUID”); an encrypted asset; a manifest (e.g., a file listing the various components of the asset); metadata associated with the asset; a license that can be open and signed as associated with a particular provider; a chunklist (e.g., a list of video and audio clips and their order); playlists (e.g., information related to which video and audio clips to include in a particular version of the asset such as for a director's cut); images (e.g., for an on-screen display); and clips which can include video clips, audio clips, subtitles, or any combination of these.

In some embodiments, an online licensing closing tool can be provided which functions to notarize the addition of network-managed secondary restrictions from a content or network provider. In some embodiments, the chunks of the asset can be a set size that is not edited. In some embodiments, the size of the chunk can be made to be configurable. In some embodiments, the audio data rate is standard, e.g., 48 kHz, to reduce or eliminate synchronization issues.

### Example Licensing Tool

A license tool can be provided within this architecture to provide digital rights management functionality and to interact with any DRM systems to control player access to licensed assets. At least two mechanisms for delivery of licensed content can be through physical ingest and direct network delivery. In the case of physical ingest, a license may or may not be included with the content. In the case of network delivery, a license can be delivered when a purchase is made. In the case of pre-seeded content (e.g., content delivered to the player prior to any request by an end user), the license can be delivered once the end user makes a purchase.

A license tool can provide digital rights management functionality. The license tool can act as a mechanism to validate that the license distributed to the access module or player is valid and authorized. The access module can use the license to validate rules associated with asset playback and to enforce those rules. The license tool can restrict playback of an asset based on the parameters in the license.

The license tool can operate in the context of the access module or player and asset servers. The access module can be a small application that resides on a player. The access module can be configured to be responsible for enforcing rights management. This can mean that when new assets are loaded the access module can validate the assets and license and inform the player if it is able to play a requested asset. The access module can also be configured to communicate with an asset server to verify the validity of a license, to make sure the restrictions associated with the license have not been modified, and/or to determine if a new license should be issued. The access module can be a conduit through which new licenses are distributed from content providers directly to a player.

The asset servers can acts as a master authority in regard to licenses and handle creation and distribution of licenses. The asset server can act as the holder of master records regarding licenses. When an access module calls home the asset server is responsible for providing a second level of validation to an already distributed license.

The asset servers can also be responsible for the distribution and creation of licenses. When an end user purchases a new license the asset server can collect all the new restrictions and generate a new license file with a signature, which can be configured such that only an access module can validate. In some embodiments, the server has the ability to encrypt the license and distribute it encrypted as an added layer of security. This can mean that only an access module can decrypt the license to add it to the player, or alternatively the access module can be configured to send a request back to the asset servers to gain the ability to decrypt the license.

The system can be configured to work in conjunction with a website provided by a content provider. When an end user views the content provider's website they may be able to purchase licenses for various pieces of content, depending on the account of the end user and the chosen piece of content. The website can be configured to make a request to the asset server to generate a new license and distribute it through the access module to the player.

The system can be configured to work in conjunction with physically ingesting content or assets at the player such as when a piece of content is placed on a piece of hardware (e.g., a hard drive, flash drive, optical disk, etc.) for distribution. The content can be distributed with or without a license. If distributed without a license, the content can be added to the player and playback can be restricted until a license is distributed and validated. If the license is included with the content, the access module can validate the license and request an asset server to decrypt and/or validate that the license is still valid. While communicating with the server, the access module can be configured to determine if there has been an update to the license and, if so, to signal the server to generate and distribute a new license.

The license tool can be configured to sign a license through the use of a key. This can mean that the original license is valid and can be understood by the player and asset server. Signed licenses can be configured to be nested within each other. This can mean that a license can be further restricted and embedded in a new license, then signed a second time to validate that the player, access module, and/or asset server enforce the rules and restrictions.

The license tool can be configured to encrypt the license. This can mean that the plain text restrictive elements can be encrypted. This adds an additional level of complexity to prevent hacking. This also allows licenses to be distributed in an additional secure method. The encryption can be based on the restriction list or can be per player, access module, asset server, etc.

Each piece of content can be configured to be an independent asset, capable of being accessed and played on its own. However, in some embodiments, the asset can be configured to require a valid license in order to be played. A license can be used to restrict access to assets. The player can play a piece of content tagged for licensing when the license is valid, for example. However, the access module and asset server can be configured to add custom restrictions to a license to prevent a piece of content from being played unless the license is not only valid but meets all the rules associated with the custom restrictions.

### Additional Examples and Embodiments

The following is a list of numbered example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure.

In embodiment 1, a content distribution system is provided, the system comprising an encoder module configured to receive an asset and to generate an encoded asset; a license module configured to receive an author license and to generate a modified license. The system also includes a key module configured to using a symmetric key, encrypt the encoded asset to generate an encrypted asset; using a first asymmetric key, encrypt the modified license and the symmetric key to generate a base-encrypted license and symmetric key; using a second asymmetric key, encrypt the base-encrypted license and symmetric key to generate a target-encrypted license and symmetric key. The system also includes a distribution server configured to transmit the encrypted asset and the target-encrypted license and symmetric key to a recipient system. The first asymmetric key comprises a public key corresponding to a private key on a playback system. The second asymmetric key comprises a public key corresponding to a private key on the recipient system.

The system of embodiment 2 includes all the elements of embodiment 1, wherein the key module is further configured to generate the symmetric key. The system of embodiment 3 includes all the elements of embodiment 2, wherein the key module randomly generates the symmetric key. The system of embodiment 4 includes all the elements of any of embodiments 1 to 3, wherein the author license comprises restrictions on access to the asset. The system embodiment of 5 includes all the elements of embodiment 4, wherein the modified license comprises restrictions on access to the asset added to the author license. The system of embodiment 6 includes all the elements of any of embodiments 1 to 5, wherein the encoded asset comprises a plurality of clips of audiovisual content, and a playlist comprising a list of a subset of the plurality of clips of audiovisual content, and an order in which to present the subset of the plurality of clips of audiovisual content. The system of embodiment 7 includes all the elements of any of embodiments 1 to 6, wherein the encoded asset comprises a plurality of clips of audiovisual content, a plurality of versions of an audiovisual presentation, and for each of the plurality of versions of the audiovisual presentation, a playlist comprising a list of a subset of the plurality of clips of audiovisual content, and an order in which to present the subset of the plurality of clips of audiovisual content. The system of embodiment 8 includes all the elements of any of embodiments 1 to 7, wherein the playback system is the recipient system. The system of embodiment 9 includes all the elements of any of embodiments 1 to 8, wherein the recipient system is a content distributor. The system of embodiment 10 includes all the elements of any of embodiments 1 to 9, and further comprises a control system configured to provide commands to the recipient system, the commands being selected from a library of operations on the recipient system. The system of embodiment 11 includes all the elements of embodiment 10, wherein the commands are transmitted to the recipient system separate from transmission of the encoded asset. The system of embodiment 12 includes all the elements of embodiment 10, wherein the commands are transmitted to the recipient system separate from transmission of the target-encoded license and symmetric key.

In embodiment 13, an audiovisual player is provided comprising non-transitory data storage configured to store one or more private encryption keys configured to decrypt information encoded with corresponding public encryption keys; at least one computing device comprising computer hardware and configured to enable operation in at least a first computing environment and a second computing environment, the second computing environment separate from the first computing environment and providing restricted access, the at least one computing device in communication with the data storage and configured, while operating in the first computing environment, to: access a library of operations; receive commands from a content delivery system; and generate operation requests based on the received commands wherein the operation requests are selected from the library of operations; and the at least one computing device further configured, while operating in the second computing environment, to: receive operation requests from the access module; perform tasks corresponding to the received operation requests; and decrypt a license associated with the asset using the one or more private encryption keys to, the license comprising restrictions on access to the asset; and provide an audiovisual data stream corresponding to an asset.

The audiovisual player of embodiment 14 includes all the elements of embodiment 13, wherein the audiovisual player is incorporated into a television. The audiovisual player of embodiment 15 includes all the elements of any of embodiments 13 to 14, wherein the audiovisual player is a standalone device configured to deliver the audiovisual data stream to a display device through a wired or wireless connection. The audiovisual player of embodiment 16 includes all the elements of any of embodiments 13 to 15, wherein the secure module comprises a decryption module configured to use the one or more private encryption keys to decrypt the asset. The audiovisual player of embodiment 17 includes all the elements of any of embodiments 13 to 16, wherein the secure module is further configured to analyze the restriction on access to the asset to determine whether an updated license should be requested. The audiovisual player of embodiment 18 includes all the elements of any of embodiments 13 to 17, wherein the playback module is further configured to verify whether playback of the asset is permitted based on the restrictions in the license. The audiovisual player of embodiment 19 includes all the elements of any of embodiments 13 to 18, wherein the asset comprises a plurality of clips of audiovisual content, a plurality of versions of an audiovisual presentation, and for each of the plurality of versions of the audiovisual presentation, a playlist comprising a list of a subset of the plurality of clips of audiovisual content, and an order in which to present the subset of the plurality of clips of audiovisual content. The audiovisual player of embodiment 20 includes all the elements of embodiment 19, wherein the playback module is further configured to read a playlist of the asset such that the audiovisual data stream comprises the subset of the plurality of clips of audiovisual contents provided in the order dictated by the playlist. The audiovisual player of embodiment 21 includes all the elements of any of embodiments 13 to 20, wherein the access module is configured to act as a node in a network upon receiving a corresponding command from the content delivery system. The audiovisual player of embodiment 22 includes all the elements of embodiment 21, wherein the access module is configured to provide peer-to-peer data transmission to other nodes in the network. The audiovisual player of embodiment 23 includes all the elements of embodiment 22, wherein the peer-to-peer data transmission utilizes the bit-torrent protocol. The audiovisual player of embodiment 24 includes all the elements of embodiment 22, wherein the playback module is configured to receive the asset over a network. The audiovisual player of embodiment 25 includes all the elements of embodiment 24, wherein the playback module is configured to provide the audiovisual data stream corresponding to the asset after the asset has been completely received. The audiovisual player of embodiment 26 includes all the elements of embodiment 24, wherein the playback module is configured to provide the audiovisual data stream corresponding to the asset while the asset is being received over the network.

In embodiment 27, a method for distributing audiovisual content is provided, the method comprising, by one or more processors comprising digital logic circuitry, receiving an audiovisual asset comprising one or more audiovisual presentations; receiving an author license associated with the audiovisual asset, the author license comprising restrictions on access to the audiovisual asset; generating a plurality of audiovisual clips from the audiovisual asset; generating a playlist for at least one of the one or more audiovisual presentations. The playlist includes a list of a subset of the plurality of audiovisual clips, and an order in which to present the subset of the plurality of audiovisual clips. The method further includes modifying the author license to include additional restrictions on access to the audiovisual asset to create a modified license; and signing the modified license using a digital certificate to create a signed license.

The method of embodiment 28 includes all the elements of embodiment 27, and further includes encrypting the audiovisual asset using a symmetric key; generating a base-encrypted license and symmetric key by using a first asymmetric key to encrypt the signed license and symmetric key; generating a target-encrypted license and symmetric key by using a second asymmetric key to encrypt the base-encrypted license and symmetric key; transmitting the encrypted audiovisual asset and the target-encrypted symmetric key and target-encrypted modified license to a recipient system, wherein the first asymmetric key comprises a public key corresponding to a private key on a playback system, and wherein the second asymmetric key comprises a public key corresponding to a private key on the recipient system. The method of embodiment 29 includes all the elements of any of embodiments 27 to 28, and further includes generating commands to transmit to the playback system, wherein the commands are selected from a library of commands on the playback system.

In embodiment 30, a method of displaying an audiovisual presentation using an audiovisual player is provided, the method comprising, by one or more processors comprising digital logic circuitry, receiving an audiovisual asset wherein the audiovisual asset comprises a plurality of audiovisual clips and one or more playlists corresponding to one or more presentations of the audiovisual asset; receiving a license associated with the audiovisual asset; identifying restrictions in the license associated with the audiovisual asset; receiving a request to access one of the one or more presentations of the audiovisual asset; verifying whether the restrictions in the license allow the audiovisual asset to be accessed; reading a playlist associated with the requested presentation of the audiovisual asset; and if the restrictions in the license allow the audiovisual asset to be accessed, generating an audiovisual stream using the playlist wherein the audiovisual stream comprises a sequence of one or more of the plurality of audiovisual clips, the sequence dictated by the playlist.

The method of embodiment 31 includes all the elements of embodiment 30, wherein the restrictions in the license comprise at least one of a date restriction, a time restriction, or a restriction on accessible presentations of the audiovisual asset. The method of embodiment 32 includes all the elements of any of embodiments 30 to 31, wherein receiving the audiovisual asset comprises receiving a digital file transmitted across a network. The method of embodiment 33 includes all the elements of embodiment 32, wherein generating the audiovisual stream occurs after receiving a portion of the audiovisual asset. The method of embodiment 34 includes all the elements of embodiment 33, wherein generating the audiovisual stream occurs after receiving the entirety of the audiovisual asset. The method of embodiment 35 includes all the elements of any of embodiments 30-34, wherein receiving the audiovisual asset comprises physical ingest of a digital file from a non-transitory storage medium releasably connected to the audiovisual player. The method of embodiment 36 includes all the elements of any of embodiments 30-34, further comprising authenticating the received license. The method of embodiment 37 includes all the elements of embodiment 36, wherein authenticating the received license comprises checking a digital signature of the received license against a root public key. The method of embodiment 38 includes all the elements of any of embodiments 30 to 37, further comprising decrypting the audiovisual asset using a symmetric key. The method of embodiment 39 includes all the elements of embodiment 38, and further includes decrypting a target-encrypted symmetric key using a first asymmetric key to obtain a base-encrypted symmetric key; and decrypting the base-encrypted symmetric key using a second asymmetric key to obtain the symmetric key, wherein the first asymmetric key is a private key corresponding to a public key used to generate the target-encrypted symmetric key, and wherein the second asymmetric key is a private key corresponding to a public key used to generate the base-encrypted symmetric key. The method of embodiment 40 includes all the elements of any of embodiments 30 to 39, and further includes decrypting a target-encrypted license using a first asymmetric key to obtain a base-encrypted license; and decrypting the base-encrypted license using a second asymmetric key to obtain the license, wherein the first asymmetric key is a private key corresponding to a public key used to generate the target-encrypted license, and wherein the second asymmetric key is a private key corresponding to a public key used to generate the base-encrypted license.

In embodiment 41, a licensing system for an audiovisual asset is provided, the licensing system comprising non-transitory data storage configured to store one or more public encryption keys configured to encrypt information to be decoded with corresponding private encryption keys and a content distributor certificate for signing digital licenses; at least one computing device comprising computer hardware and in communication with the data storage, the at least one computing device configured to receive an author license associated with an audiovisual asset, the author license comprising restrictions on access to the audiovisual asset; receive a restrictions list from a digital rights manager of a content distributor; receive a request from a recipient to access the audiovisual asset; generate a new license by adding restrictions to the restrictions in the author license; sign the new license using the stored content distributor certificate; and encrypt the signed license using a public encryption key associated with a recipient of the audiovisual asset.

In embodiment 42, a content distribution system is provided comprising a key system comprising one or more computing devices comprising computer hardware, the key system configured to using a symmetric key, encrypt an encoded asset to generate an encrypted asset; using a first asymmetric key, encrypt a modified license and the symmetric key to generate a base-encrypted license and symmetric key, the modified license derived from an author license; using a second asymmetric key, encrypt the base-encrypted license and symmetric key to generate a target-encrypted license and symmetric key; and a distribution server comprising one or more computing devices comprising computer hardware, the distribution system configured to transmit the encrypted asset and the target-encrypted license and symmetric key to a recipient system, wherein the first asymmetric key comprises a public key corresponding to a private key on a playback system, and wherein the second asymmetric key comprises a public key corresponding to a private key on the recipient system.

The content distribution system of embodiment 43 includes all the elements of embodiment 42, wherein the one or more computing devices of the key system are the same as the one or more computing devices of the distribution server.

### CONCLUSION

Embodiments have been described in connection with the accompanying drawings. The foregoing embodiments have been described at a level of detail to allow one of ordinary skill in the art to make and use the devices, systems, etc. described herein. A wide variety of variation is possible. Components, elements, and/or steps can be altered, added, removed, or rearranged. While certain embodiments have been explicitly described, other embodiments will become apparent to those of ordinary skill in the art based on this disclosure.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. In some embodiments, the algorithms disclosed herein can be implemented as routines stored in a memory device, such as on a non-transitory storage medium. Additionally, computer hardware, such as one or more physical processors, can be configured to execute the routines. The physical processors can include digital logic circuitry. In some embodiments, custom circuitry may be used.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. For example, computing hardware can be used to execute a module implemented using hardware, software, firmware, or any combination of these.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” or “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z each to be present.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A content distribution system comprising:
a key system comprising one or more computing devices comprising computer hardware, the key system configured to:
using a symmetric key, encrypt an encoded asset to generate an encrypted asset;
using a first asymmetric key, encrypt a modified license and the symmetric key to generate a base-encrypted license and symmetric key, the modified license derived from an author license;
using a second asymmetric key, encrypt the base-encrypted license and symmetric key to generate a target-encrypted license and symmetric key; and
a distribution server comprising one or more computing devices comprising computer hardware, the distribution system configured to transmit the encrypted asset and the target-encrypted license and symmetric key to a recipient system,
wherein the first asymmetric key comprises a public key corresponding to a private key on a playback system, and
wherein the second asymmetric key comprises a public key corresponding to a private key on the recipient system.

2. The content distribution system of claim 1, wherein the key module is further configured to generate the symmetric key.

3. The content distribution system of claim 2, wherein the key module randomly generates the symmetric key.

4. The content distribution system of claim 1, wherein the author license comprises restrictions on access to the asset.

5. The content distribution system of claim 4, wherein the modified license comprises restrictions on access to the asset added to the author license.

6. The content distribution system of claim 1, wherein the encoded asset comprises:
a plurality of clips of audiovisual content, and
a playlist comprising:
a list of a subset of the plurality of clips of audiovisual content, and
an order in which to present the subset of the plurality of clips of audiovisual content.

7. The content distribution system of claim 1, wherein the encoded asset comprises:
a plurality of clips of audiovisual content,
a plurality of versions of an audiovisual presentation, and
for each of the plurality of versions of the audiovisual presentation, a playlist comprising:
a list of a subset of the plurality of clips of audiovisual content, and
an order in which to present the subset of the plurality of clips of audiovisual content.

8. The content distribution system of claim 1, wherein the playback system is the recipient system.

9. The content distribution system of claim 1, wherein the recipient system is a content distributor.

10. The content distribution system of claim 1, further comprising a control system configured to provide commands to the recipient system, the commands being selected from a library of operations on the recipient system.

11. The content distribution system of claim 10, wherein the commands are transmitted to the recipient system separate from transmission of the encoded asset.

12. The content distribution system of claim 10, wherein the commands are transmitted to the recipient system separate from transmission of the target-encoded license and symmetric key.

13. The content distribution system of claim 1, wherein the one or more computing devices of the key system are the same as the one or more computing devices of the distribution server.
